(19) United States
(12) Patent Application Publication
(10) Pub. No.: US 2018/0278997 A1
(43) Pub. Date: Sep. 27, 2018

(54) PARENTAL ACCESS CONTROL OF MEDIA CONTENT

(71) Applicant: OpenTV, Inc., San Francisco, CA (US)

(72) Inventors: Mehmet Hakan Isbiliroglu, San Jose, CA (US); Venkata Rao Yadlapalli, San Jose, CA (US); Rohan Pingali, San Jose, CA (US)

(21) Appl. No.: 15/467,302

(22) Filed: Mar. 23, 2017

(51) Int. Cl. H04N 21/45

(52) U.S. Cl. CPC H04N 21/4532

(57) ABSTRACT

Example embodiments facilitate parental access control of media content. In an example embodiment, an identification corresponding to a viewing profile stored in a database is received. The viewing profile includes media content information identifying an available media content item, and challenge information identifying a challenge to be presented to allow consumption of the media content item, a reference response to the challenge, and a challenge rule. A challenge is presented based on the received identification, and a response to the challenge is received. The received response is compared to the reference response. A determination is made whether presentation of the media content item is currently allowable based on the comparing of the received response to the reference response, and on the challenge rule. Based on a determination that presentation of the content item is currently allowable, the media content item is presented via a display device.

### FIELD

The present disclosure relates generally to presentation of media content and, in a specific example embodiment, to parental access control of media content.

### BACKGROUND

In the presence of the vast and continually increasing volume of media content (e.g., television shows, movies, and the like) available by way of broadcast television and online media sources, parents continue the difficult but important task of regulating the nature and amount of such content that is available to their children for consumption, as well as the circumstances under which access to that content is allowed. Television content rating systems, such as the TV Parental Guidelines employed in the United States to denote programs deemed to include violence and other potentially objectionable content, may often provide useful guideposts to parents regarding which media content items are acceptable for viewing by their children. However, some parents may hold a unique view as to what types and amounts of content are appropriate for their particular children. Consequently, a “one size fits all” approach to parental access control is unlikely to meet the needs of a wide range of families.

### BRIEF DESCRIPTION OF DRAWINGS

Various ones of the appended drawings merely illustrate example embodiments of the present disclosure and cannot be considered as limiting in scope.

FIG. 1 is a block diagram of an example media content parental control system.

FIG. 2 is a block diagram of an example access management device of the media content parental control system of FIG. 1.

FIG. 3 is a block diagram of an example content access device of the media content parental control system of FIG. 1.

FIG. 4 is a block diagram of an example configuration database system of the media content parental control system of FIG. 1.

FIG. 5 is a block diagram of an example profile database system of the media content parental control system of FIG. 1.

FIG. 6 is a flow diagram of an example method of operating the access management device of FIG. 2.

FIG. 7 is a flow diagram of an example method of operating the content access device of FIG. 3.

FIG. 8 is a simplified block diagram of a machine in an example form of a computing system within which a set of instructions for causing the machine to perform any one or more of the methodologies discussed herein may be executed.

### DETAILED DESCRIPTION

In the following description, for the purposes of explanation, numerous specific details are set forth in order to provide an understanding of various example embodiments of the present subject matter. It will be evident, however, to those skilled in the art, that example embodiments of the present subject matter may be practiced without these specific details.

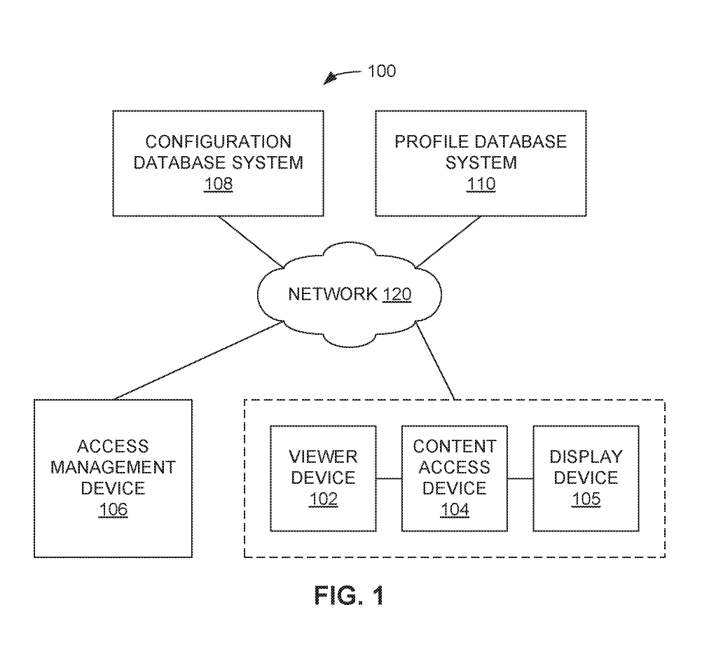

FIG. 1 is a block diagram of an example media content parental control system 100 that may be employed to control child access to media content including, but not limited to, video content, audio content, and games. In the particular embodiments discussed herein, the control system 100 is described in relation to a parent controlling access to media content by the children of the parent. However, other example embodiments involving any type of media content access by an individual or group that is to be monitored or controlled by another individual or group may employ one or more of the same aspects or principles discussed hereinafter.

As depicted in FIG. 1, the control system 100 may include a viewer device 102, a content access device 104, a display device 105, an access management device 106, a configuration database system 108, and a profile database system 110 communicatively coupled by way of a network 120. Examples of the communication network 120 may include, but are not limited to, a wide-area network (WAN) (e.g., the Internet), a local area network (LAN), a cellular network (e.g., third-generation (3G) or fourth-generation (4G) network), a cable television network, a satellite television network, a terrestrial television network, or any other communication network or connection, or combinations thereof. While one instance of each of the devices or systems 102-120 are displayed, multiple instances of such devices or systems 102-120 may be employed in other example embodiments.

The viewer device 102, the content access device 104, and the display device 105 may constitute a number of different configurations. In an example embodiment, the viewer device 102, the content access device 104, and the display device 105 may be separate, but communicatively intercoupled devices. For example, the display device 105 may be a television or video monitor, while the content access device 104 may be a television set-top box, video streaming device, gaming system, or the like. Consequently, the viewer device 102 may be, for example, a remote control device, a smart phone, or a tablet computer for communicating with the content access device 104. In other example embodiments, the viewer device 102 and the content access device 104 may constitute a single device including, but not limited to, a tablet computer, a smart phone, and so on, with the display device 105 comprising a television or similar large display. Moreover, in yet other example embodiments, the content access device 104 and the display device 105 may be combined as a single unit including, but not limited to, a smart television, with a remote control device, smart phone, tablet computer, or the like operating as the viewer device 102. Further, some example embodiments may incorporate the viewer device 102, the content access device 104, and the display device 105 into a single device including, but not limited to, a desktop computer and a laptop computer.

In an example embodiment, the display device 105 may be any display or presentation device configured to display or present media content (e.g., video content, audio content, games, and the like) to a viewer. In some example embodiments, the display device 105 may also present educational “challenges,” such as questions, puzzles, and other mental, intellectual, or academic challenges, for the viewer to answer or solve to allow the presentation of the desired media content. In other example embodiments, the viewer device 102 may be configured to present the challenges to the viewer, as well as the associated media content.

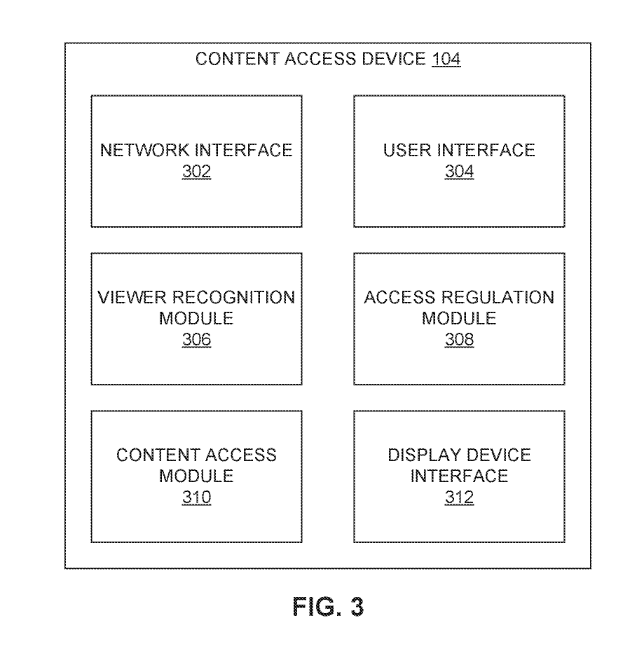

Also in an example embodiment, the content access device 104 may be configured to access and/or store the challenges and associated media content for presentation to the viewer. More generally, the content access device 104 may be configured to perform operations involved in coordinating the presentation of the challenges, the reception and reviewing of the corresponding viewer responses to the challenges, and the resulting presentation of the media content. The content access device 104 is described in greater detail below in conjunction with FIG. 3.

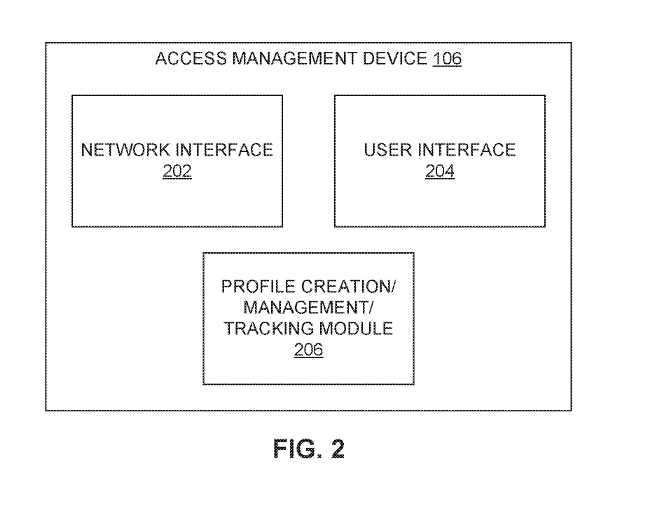

In an example embodiment, the access management device 106 may be configured to create one or more profile accounts corresponding to one or more viewers, such as under the control of a parent of the viewers. Examples of the access management device 106 may include, but are not limited to, a desktop computer, laptop computer, tablet computer, and smart phone. In some example embodiments, the content access device 104 may also serve as the access management device 106. More details concerning an example of the access management device 106 are discussed below in connection with FIG. 2.

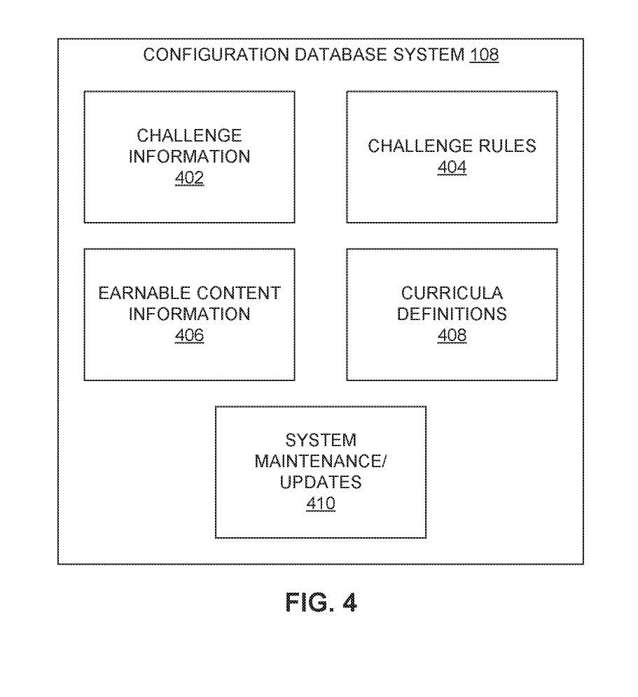

Continuing with FIG. 1, the configuration database system 108 may be configured to provide and/or store information usable and accessible by multiple parents to be implemented in the content access device 104 and/or the access management device 106. The types of information stored in the configuration database system 108 may include, for example, challenges (e.g., puzzles, academic or educational questions, and the like) and associated media content for a variety of ages, various “curricula” that employ the challenges and content, and updates to applications and/or modules that may execute in the content access device 104, the access management device 106, and other devices that support the parental access control operations described herein. The configuration database system 108 may implement any form of database, including, but not limited to, a relational database system, an object database system, and so on. An example configuration database system 108 is described in greater detail below in connection with FIG. 4.

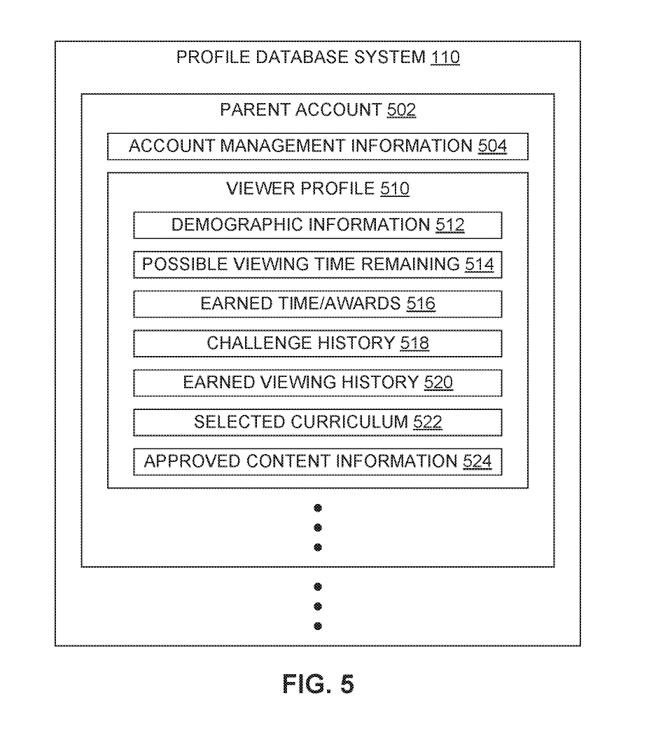

In an example embodiment, the profile database system 110 may be configured to provide and/or store information related to parental accounts and their associated profiles. Such information in the profile database system 110 may include, for example, usernames and passwords or similar information for the parent account and each viewer (e.g., child) profile (or, alternatively, viewing profile), challenge response history; media content viewing history, earned awards; current rules and curriculum for each viewer profile, and the like. As with the configuration database system 108, the profile database system 110 may implement any form of database. An example profile database system 110 is discussed more fully in conjunction with FIG. 5.

In at least some example embodiments described in greater detail below, a parent or similar individual may closely tailor the gaming and viewing habits of their children or other viewers to the needs of those viewers by creating and monitoring a profile for each viewer that facilitates limitations on overall viewing time and the like, while automatically employing an “earn to view” environment by which a viewer may earn more viewing or gaming time by successfully responding to educational challenges. At the same time, the example embodiments described herein may also facilitate greater viewer access to the desired content by regulating access to that content without constant parental supervision.

FIG. 2 is a block diagram of an example embodiment of the access management device 106 of the media content parental control system 100 of FIG. 1. As depicted in FIG. 2, the access management device 106 may include a network interface 202, a user interface 204, and a profile creation/management/tracking module 206. In example embodiments, the various modules 202-206 of the access management device 106 may be implemented in hardware (e.g., logic circuits and other electronic components), in software or firmware in the form of instructions stored in a memory and configured to be executed on one or more hardware processors (e.g., microprocessors, microcontrollers, and the like), or some combination thereof. Also in some example embodiments, fewer than all of the modules 202-206 may be implemented, and additional modules other than those explicitly depicted in FIG. 2 may be employed.

The network interface 202 may be configured to access the information stored in the configuration database system 108 and the profile database system 110. In an example embodiment, the network interface 202 may include one or more of a WAN (e.g., Internet) interface, an Ethernet local area network (LAN) interface, a wireless LAN (e.g., WiFi®, Bluetooth®; and so on) interface, a wireless cellular (e.g., Long-Term Evolution (LTE®)) interface, a satellite broadcast interface, a cable broadcast interface, a terrestrial broadcast interface; and so on. In example embodiments; the access management device 106 may update the software of one or more of the modules 202-206 from another system (e.g., the configuration database system 108 and/or the profile database system 110) via the network 120 using the network interface 202.

The user interface 204 may be configured to receive input for, and provide output from, one or more applications or modules employed in the access management device 106, including the profile creation/management/tracking module 206. Example embodiments of the user interface 204 may include, but are not limited to, a keyboard, mouse, touchscreen, camera, microphone, speakers, remote control device, and so on.

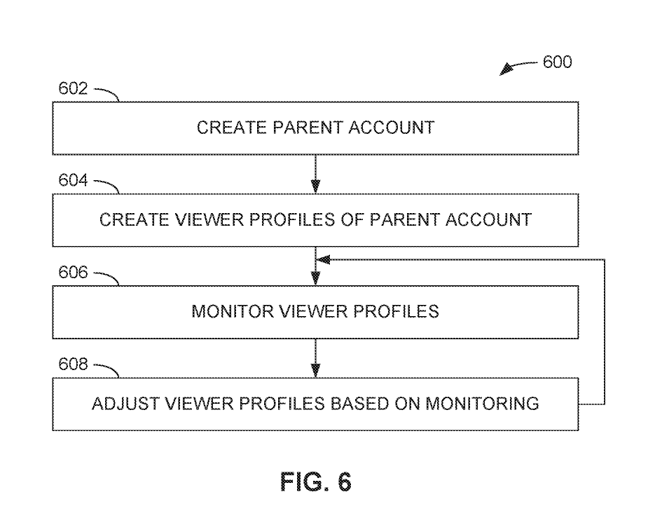

In an example embodiment, the profile creation/management/tracking module 206 may be configured to engage and manage the overall parental access control process and features described herein. For example, the profile creation/management/tracking module 206 may be employed to create a user (e.g., parental) account and associated viewer profiles, as well as monitor and adjust the viewer profiles, at the profile database system 110 via the network interface 202. In some example embodiments, the profile creation/management/tracking module 206 also may be utilized to access the configuration database system 108, such as system updates for the profile creation/management/tracking module 206. In example embodiments, the profile creation/management/tracking module 206 may be an application executing on a desktop, laptop, or tablet computer, or on a smartphone or other computing device. An example embodiment of a method executable by the profile creation/management/tracking module 206 is discussed below in conjunction with FIG. 6.

FIG. 3 is a block diagram of an example of the content access device 104 of the media content parental control system 100 of FIG. 1. As shown in FIG. 3, the content access device 104 may include a network interface 302, a user interface 304, a viewer recognition module 306, an access regulation module 308, a content access module 310, and a display device interface 312. In example embodiments, the various modules 302-312 of the content access device 104 may be implemented in hardware (e.g., logic circuits and other electronic components), in software or firmware in the form of instructions stored in a memory and configured to be executed on one or more hardware processors (e.g., microprocessors, microcontrollers, and the like), or some combination thereof. Also in some example embodiments, fewer than all of the modules 302-312 may be implemented, and additional modules other than those explicitly depicted in FIG. 3 may be employed.

In example embodiments, the network interface 302 and the user interface 304 may be configured in a manner similar to the network interface 202 and the user interface 204 of the access management device 106 of FIG. 2. More specifically, the network interface 302 may be configured to access the configuration database system 108 via the network interface 202, such as to receive challenges, associated media content, system updates, and so on, as well as the profile database system 110, such as to receive information from, as well as to update, one or more viewer profiles associated with the content access device 104. In example embodiments, the content access device 104 may update the software of one or more of the modules 302-312 from another system (e.g., the configuration database system 108 and/or the profile database system 110) via the network 120 using the network interface 302.

The user interface 304, in an example embodiment, may be configured to receive input for, and provide output from, one or more applications or modules employed in the content access device 104, including the viewer recognition module 306, the access regulation module 308, and the content access module 310. Example embodiments of the user interface 304 may include, but are not limited to, a keyboard, mouse, touchscreen, camera, microphone, speakers, remote control device, and so on. In one example embodiment, the user interface 304 may receive viewer input from the viewer device 102, such as identification information of the viewer requesting access to media content.

In an example embodiment, the viewer recognition module 306 may be configured to receive viewer identification information, such as one or more of a username, password, a selection of a series of numbers or graphical objects, or any other means of identifying a viewer for which a viewer profile has been created, such as from the user interface 304 and/or a separate device, such as the viewer device 102 of FIG. 1. In one example embodiment, the viewer recognition module 306 may recognize the viewer in response to the viewer device 102 entering within some distance of the content access device 104 that allows the automatic wireless transmission of the identification information from the viewer device 102 to the content access device 104. In response to receiving the identification information; the viewer recognition module 306 may access profile information (e.g., from the profile database system 110) to identify the viewer profile corresponding to the identification information, and forward the identity of the viewer profile to the access regulation module 308.

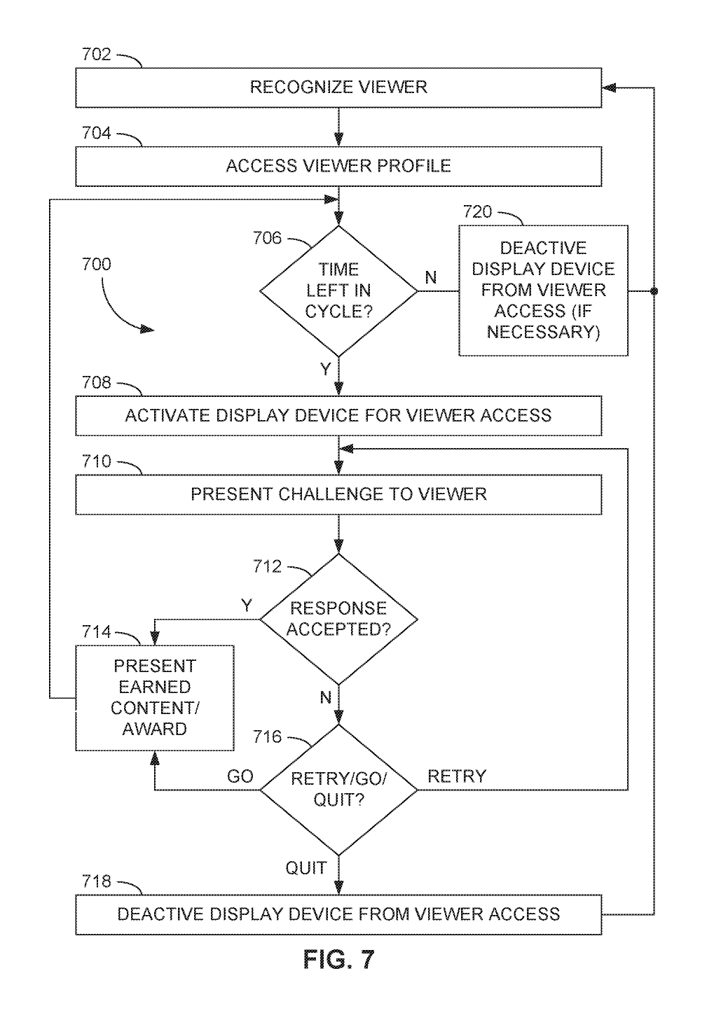

The access regulation module 308, in an example embodiment, may be configured to control or regulate access by the identified viewer to media content, such as television programs, movies, games, and so on, using the identified viewer profile. For example, the access regulation module 308 may present one or more challenges, such as educational questions or puzzles, on the display device 105 via the display device interface 312, or via an interface with the viewer device 102, to the identified viewer. The access regulation module 308, via the viewer device 102 or the user interface 304, may receive one or more responses to the questions or puzzles. The access regulation module 308 may then determine whether those responses are acceptable (e.g., whether they are correct, nearly correct, and so on, such as by comparing the responses to reference responses to the questions or puzzles), and then determine whether one or more media content items may be presented on the display device 105 via the display device interface 312 for viewer consumption based on the acceptability of the responses. In some example embodiments, the access regulation module 308 may access the identified viewer profile to identify the challenges to be presented, the acceptable responses to those challenges, the amount of media content that may be viewed for each acceptable response or responses, the total amount of media content that may be viewed in a particular time period, and so on. An example embodiment of a method executable by the access regulation module 308 is discussed below in connection with FIG. 7.

The content access module 310, in an example embodiment, may be configured to receive or retrieve the media content to be presented to the identified viewer, as defined or suggested in the identified viewer profile. For example, the content access module 310 may receive, and possibly record (e.g., onto non-volatile data storage), the media content via a broadcast network (e.g., via satellite, cable, and/or terrestrial means) over the network interface 302. In some example embodiments; the content access module 310 may employ the network interface 302 to receive, and possibly record, content from one or more online media content sources over a WAN (e.g., the Internet).

In Some Example Embodiments, One or More of the Viewer Recognition Module 306, the access regulation module 308, and the content access module 310 may be incorporated into one or more applications to be executed on the content access device 104. As such, the content access device 104 may be configured to update or otherwise manage the modules 306-310 via access to the configuration database system 108.

In an example embodiment, the display device interface 312 may be configured to deliver, to the display device 105, the media content allowed by the access regulation module 308, and possibly the challenges and other information intended for the identified viewer, for presentation to the identified viewer. The display device interface 312 may include, for example, a High-Definition Multimedia Interface (HDMI), component video connection, composite video connection, coaxial cable video connection, or the like. In some example embodiments, the display device 312 interface may be wired, wireless (e.g., via WiFi® or Bluetooth®), or some combination thereof.

FIG. 4 is a block diagram of an example of the configuration database system 108 of the media content parental control system 100 of FIG. 1. As illustrated in FIG. 4, the configuration database system 108 may include information such as challenge information 402, challenge rules 404, earnable content (e.g., media content and other awards) information 406, curricula definitions 408, and system maintenance/updates 410, In other example embodiments, other types of information may also be stored in the configuration database system 108.

The challenge information 402, in an example embodiment, include the challenges that may be provided to a viewer, possibly organized by viewer age and other demographic factors, knowledge level, subject matter area, and so on. In another example embodiment, the challenge information 402 may refer to another database or data storage system that stores the actual challenges. Examples of the challenges may include, but are not limited to, educational questions (e.g., questions directed to one or more particular academic subjects, such as particular areas of mathematics, science, social studies, language, and so on), puzzles (e.g., mathematical puzzles, logic puzzles (e.g., Sudoku), or “brain-teasers”), and so on. The challenges may include text, graphics, audio, video, and other types of information. In at least some example embodiments, the challenge information 402 may also include reference responses (e.g., correct answers to questions, correct solutions to puzzles, and so on) for the challenges against which the viewer responses may be compared.

In an example embodiment, the challenge rules 404 may include rules that identify or outline how the challenges are to be employed in determining whether, and which, media content is to be presented based on the responses to the challenges. For example, the challenge rules 404 may include which challenges are presented, the order in which they are presented, whether the answers or responses need an exactly or closely correct response to cause presentation of the media content, whether a number of retries will result in the media content being presented regardless of whether the responses are correct, the type or amount of media content to be shown based on acceptable responses to various challenges, and so on. Other types of challenge rules 404 may be stored in the configuration database system 108 in other example embodiments.

The earnable content information 406 may include the media content items that may be presented to the identified viewer by the display device 105, in an example embodiment. As indicated above, the media content may be video content, audio content, games, and so on. In another example embodiment, the earnable content information 406 may refer to another data storage device or system that stores the actual content, such as by way of Uniform Resource Locator (URL), broadcast channel, or other addressable means. In other examples, the earnable content information 406 may include information for awards other than media content, such as experience points for games, discounts for purchasing items, and so on.

In an example embodiment, the curricula definitions 408 may include information defining a plurality of predefined curricula, with each referring its own set of challenge information 402, challenge rules 404, and earnable content information 406. Each curriculum may be defined by a provider of the media content, a parent, a third party (e.g., an educational institution), or the like. Moreover, in some example embodiments, one or more of the curricula may be associated with a particular age group, subject matter interest, and other characteristics of a viewer.

The system maintenance/updates 410, in an example embodiment, may include updates, patches, and other upgrade or maintenance information for the profile creation/management/tracking module 206 of the access management device 106, as well as any of the viewer recognition module 306, the access regulation module 308, and the content access module 310 of the content access device 104, which may be downloaded and installed on the corresponding device.

FIG. 5 is a block diagram of an example of the profile database system 110 of the media content parental control system 100 of FIG. 1. In the example embodiment of FIG. 5, the profile database system 110 may store multiple parent accounts 502, each of which may be created and associated with a particular parent, or set of parents; corresponding to a household. Further, each parent account 502 may store or reference account management information 504 and one or more viewer profiles 510. The account management information 504 may include username, password, and other identification or authentication information; payment information; address and other contact information; and the like associated with the parent.

Each viewer profile 510 associated with a particular parent account 502, in an example embodiment, may be created by the parent associated with that parent account 502. As depicted in FIG. 5, a viewer profile 510, in an example embodiment, may include demographic information 512 corresponding to the viewer, possible viewing time (or amount) remaining 514, earned viewing time/awards 516, challenge history 518, earned viewing history 520, an indication of a selected curriculum 522 for the viewer, and approved content information 524 applicable to the viewer.

More specifically in an example embodiment, the demographic information 512 (e.g., age, gender, educational interests, media content preferences, and so on) may be optional, and may serve as a basis by which the profile database system 110 may suggest or recommend one or more curricula that may be especially applicable to the viewer represented by the viewer profile 510. The possible viewing time (or amount) remaining 514 information may indicate the amount of time that the viewer may earn during a current viewing time period or cycle; such as a day or week. The earned time/awards 516 information may indicate the amount or time of media content, as well as other awards (e.g., experience points, purchase discounts, etc.) that the viewer has earned but has not yet consumed. For example, the earned awards 516 information may include tickets for movies, game arcades, and so on, as well as other enticements selected by a parent in order to expand the awards provided beyond the media content viewing context. The challenge history 518 may include information regarding the challenges previously presented to the viewer, the responses to those challenges by the viewer, whether the responses were correct or otherwise acceptable, and so on. The earned viewing history 520 may include information indicating the particular media content items the viewer has earned and consumed based on the various challenge responses of the viewer. The selected curriculum 522 may indicate a particular curriculum, such as one referred to by one of the curricula definitions 408 stored in the configuration database system 108, currently being applied to the viewer. The approved content information 524 may include names, URLs, and/or other identifiers indicating particular content, or types of content, that are approved by the parent for viewing by the viewer. Other information may also be stored in the viewer profile 510 in other example embodiments.

FIG. 6 is a flow diagram of an example method 600 of operating the access management device 106 of FIG. 2. While the operations of the method 600 and others discussed below are described hereinafter in relation to the various modules 202-206 of the access management device 106, other devices or modules not described herein may perform the operations in other example embodiments. Also, while the operations of the method 600 of FIG. 6, as well as those of other methods described herein, are presented in a particular order, other orders of execution are also possible, including simultaneous, concurrent, or overlapping execution of two or more operations.

In the method 600, a parent may employ the profile creation/management/tracking module 206 via the user interface 204 to create a parent account 502 at the profile database system 110 by way of the network interface 202 (operation 602). In an example embodiment, creation of the parent account 502 may include the entering of a username, password, and/or other identification or authentication information; payment information; contact information; and so on via the user interface 204. Subsequent to, or as part of the creation of the parent account 502, the parent may also use the profile creation/management/tracking module 206 to create or define one or more viewer profiles 510 (operation 604) (e.g., one for each child of the parent), which may include specifying the demographic information 512 and selected curriculum 522 corresponding to that viewer. In an example embodiment, the parent may select a predefined curriculum from the curricula definitions 408 and/or may select individual challenges 402 and corresponding earnable content information 406 for presentation to the viewer as part of a custom curriculum.

As the viewer uses the content access device 104, as is discussed in greater detail with respect to FIG. 7 below, the parent may use the profile creation/management/tracking module 206 to monitor one or more of the viewer profiles 510 (operation 606) (e.g., the possible viewing time remaining 514, the earned media content and other awards 516, the challenge history 518, and the earned viewing history 520) to check the progress and interest level of the viewer in the challenges and associated media content. Based on the monitoring and/or other factors (e.g., general behavior of the viewer), the parent may use the profile creation/management/tracking module 206 to adjust the viewer profile 510 (operation 608) (e.g., by changing the selected curriculum 522, the earned viewing time remaining 514, and/or earned awards 516).

FIG. 7 is a flow diagram of an example method 700 to facilitate an “earn to view” environment. While the method is described below as being performed by the content access device 104 of FIG. 3 and its various modules 302-312, devices or systems other than those specifically described herein may be employed to perform the method 700 in other example embodiments.

In the method 700, the viewer recognition module 306 may recognize a viewer requesting access to media content (operation 702). In an example embodiment, the viewer recognition module 306 may receive a username, password, and/or other identification information via the user interface 304 (e.g., from a remote control device for the content access device 104) or via the network interface 302 (e.g., from the separate viewer device 102, such as a smartphone or tablet computer). In another example embodiment, the viewer recognition module 306 may receive the identification information in response to the viewer device 102 or remote control device entering within a wireless communication range of the content access device 104, such as within a range of a Bluetooth® connection between the viewer device 102 and the content access device 104.

Based on the recognition of the viewer, the viewer recognition module 306 or the access regulation module 308 may access the viewer profile 510 corresponding to the recognized viewer (operation 704). In an example embodiment, the viewer recognition module 306 or the access regulation module 308 may access the viewer profile 510 from the profile database system 110 via the network 120 and the network interface 302. In some example embodiments, the content access device 104 may have previously cached the viewer profile 510, thus facilitating local access to the viewer profile 510.

In an example embodiment, the access regulation module 308 may determine whether the recognized viewer currently possesses any possible time, amount, or credit with which to consume media content (operation 706), such as by way of the possible viewing time remaining 514 data of the viewer profile 510. For example, the viewer profile 510 may indicate that the corresponding viewer has only one hour of viewing time remaining for the current week. If no time or very little time remains, the access regulation module 308 may inform the viewer (e.g., via the display device 105 or the viewer device 102) of that fact and return to a state in which another viewer may be recognized (operation 702).

If, instead, a sufficient amount or time period currently remains for the viewer to consume media content (operation 706), the access regulation module 308 may activate the display device 105 for use by the viewer (operation 708) if not already done so, and present one or more challenges (e.g., questions and/or puzzles) to the viewer via the display device 105 or the viewer device 102 (operation 710). The particular challenges presented may be based, in an example embodiment, on one or more of the selected curriculum 522, challenge history 518, and earned viewing history 520 of the viewer profile 510, as well as the challenge information 402, challenge rules 404, earnable content information 406, and curricula definitions 408 stored in the configuration database system 108.

Based on whether the responses to the presented challenges received from the viewer (e.g., via the viewer device 102 or a remote control device) are acceptable (operation 712) (e.g., by way of comparing the responses to predetermined reference responses), the access regulation module 308 may cause the presentation of a corresponding earned media content and/or other award to the viewer (operation 714) (e.g., on the display device 105 via the display device interface 312). Depending on information provided in the viewer profile 510, the access regulation module 308 may only consider completely correct responses as acceptable, or may consider a majority (or some particular minimum number) of correct responses as acceptable. If the responses provided by the viewer are not acceptable (operation 712), the access regulation module 308 (e.g., depending on information in the viewer profile 510) may determine (operation 716) whether to allow the viewer to retry providing responses to either the same or different challenges (operation 710), allow presentation of the media content anyway (operation 714) (e.g., after some predetermined number of tries indicated in the viewer profile 510), or deactivate the display device 105 from viewer access (operation 718) and return to a viewer recognizing state (operation 702).

In example embodiments, the one or more responses provided by the viewer may be depend on the nature of the presented challenge, as well as other factors. For example, the challenge may be a multiple-choice question, in response to which the viewer selects one (or more) of the multiple answer choices presented as part of the challenge, such as by way of a touchscreen or microphone (e.g., using speech-to-text (STT) software) of the viewer device 102 or a remote control device). In other examples, the challenge may be a fill-in-the-blank question, a short answer question, or the like. Other types of manual and/or verbal viewer input may also be used in other example embodiments. Additionally, the interpretation of the viewer responses may occur at the access regulation module 308 of the content access device 104, or at the configuration database system 108, profile database system 110, or another device or system accessible via the network 120.

The access regulation module 308 may cause presentation of the earned media content by way of playing content live from a particular broadcast channel, online content source, or the like, or by way of playing previously recorded media content at the content access device 104 from such sources (e.g., via the content access module 310). In an example embodiment, the access regulation module 308 may receive the media content, or the identification thereof, from the earnable content information 406 of the configuration database system 108. Also in an example embodiment, the earned media content may be presented to the viewer via the viewer device 102, especially during times that the display device 105 is not available for that purpose.

In addition, in an example embodiment, during the execution of the method 700, the access regulation module 308 may update the possible viewing time remaining 514, the earned time/awards 516, the challenge history 518, and/or the earned viewing history 520 of the corresponding viewer profile 510 of the current viewer based on the presented challenges and media content, as well as the received responses to the challenges. As indicated above, the parent, via the access management device 106, may monitor that information to track the activities of the viewer, as well as modify aspects of the corresponding viewer profile 510 (e.g., the selected curriculum 522, the possible viewing time remaining 514, or the earned time/awards 516) that may affect subsequent aspects of the “learn to view” environment of the viewer.

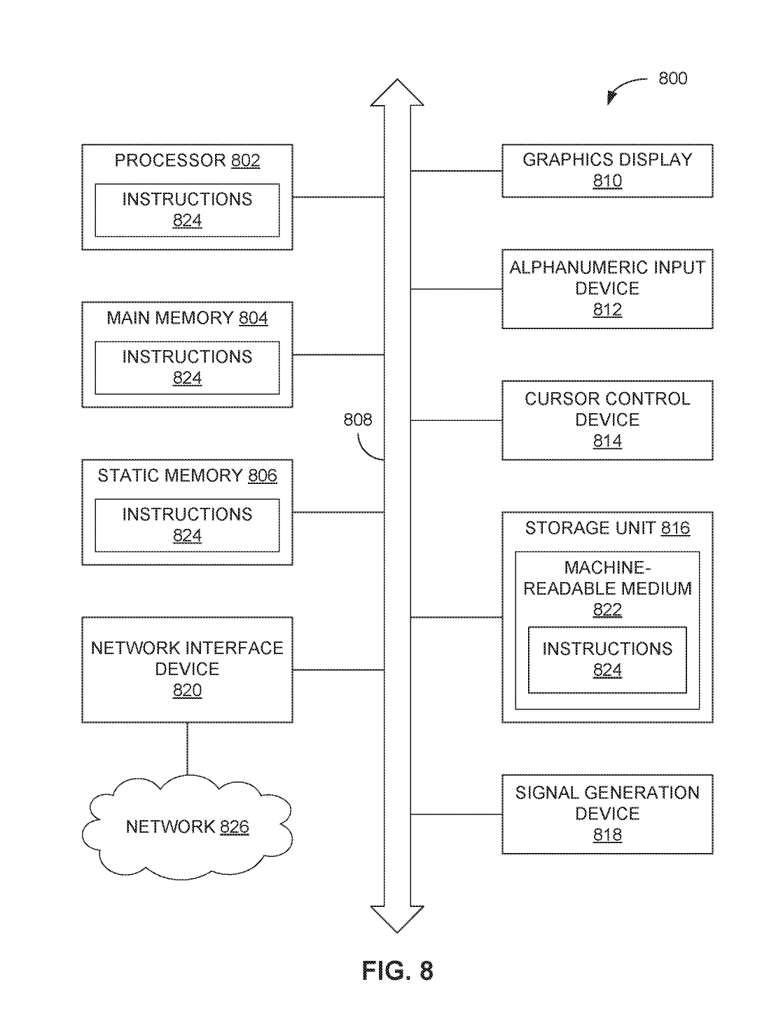

FIG. 8 is a block diagram illustrating components of a machine 800, according to some example embodiments, able to read instructions 824 from a machine-readable medium 822 (e.g., a non-transitory machine-readable medium, a machine-readable storage medium, or a computer-readable storage medium) and perform any one or more of the methodologies discussed herein, in whole or in part. Specifically, FIG. 8 depicts the machine 800 in the example form of a computer device (e.g., a computer) within which the instructions 824 (e.g., software, firmware, a program, an application, an applet, an app, or other executable code) for causing the machine 800 to perform any one or more of the methodologies discussed herein, in whole or in part.

For example, the instructions 824 may cause the machine 800 to execute the methods 600, 700 of FIGS. 6 and 7, as well as all example embodiments associated therewith. The instructions 824 can transform the general, non-programmed machine 800 into a particular machine (e.g., specially configured machine) programmed to carry out the described and illustrated functions in the manner described. Also, in example embodiments, the machine 800 may operate as one or more of the modules 202-206 of the access management device 106 of FIG. 2, the modules 302-312 of the content access device 104 of FIG. 3, or any other computing system or device described herein.

In example embodiments, the machine 800 operates as a standalone device or may be connected (e.g., networked) to other machines. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, a power adapter, or any machine 800 capable of executing the instructions 824, sequentially or otherwise, that specify actions to be taken by that machine 800. Further, while only a single machine 800 is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application-specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light-emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible machine-readable storage medium) on which are stored the instructions 824 embodying any one or more of the methodologies or functions described herein. The instructions 824 may also reside, completely or at least partially, within the main memory 804, within the processor 802 (e.g., within a cache memory of the processor 802), or both, before or during execution thereof by the machine 800. Accordingly, the main memory 804 and the processor 802 may be considered machine-readable media 822 (e.g., tangible and non-transitory machine-readable media).

In some example embodiments, the machine 800 may be a portable or mobile computing device and have one or more additional input components (e.g., sensors or gauges). Examples of such input components include an image input component (e.g., one or more cameras), an audio input component (e.g., a microphone), a direction input component (e.g., a compass), a location input component (e.g., a Global Positioning System (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions 824 for execution by a machine (e.g., machine 800), such that the instructions 824, when executed by one or more processors of the machine 800 (e.g., processor 802), cause the machine 800 to perform any one or more of the methodologies described herein. The term “machine-readable medium” shall accordingly be taken to include, but not be limited to, one or more data repositories in the form of a solid-state memory, an optical medium, a magnetic medium, or any suitable combination thereof.

Furthermore; the machine-readable medium 822 is non-transitory in that it does not embody a propagating or transitory signal. However, labeling the machine-readable medium 822 as “non-transitory” should not be construed to mean that the medium is incapable of movement; the medium should be considered as being transportable from one physical location to another in some example embodiments. Additionally, since the machine-readable medium 822 is tangible, the medium may be considered a machine-readable device.

The instructions 824 may further be transmitted or received over a communications network 826 using a transmission medium via the network interface device 820 and utilizing any one of a number of well-known transfer protocols (e.g., Hypertext Transfer Protocol (HTTP)). Examples of communication networks 826 include a local area network (LAN), a wide area network (WAN), the Internet, mobile telephone networks, plain old telephone service (POTS) networks, and wireless data networks (e.g., Wi-Fi®, LTE®, and WIMAX® networks). The term “transmission medium” shall be taken to include any intangible medium that is capable of storing, encoding, or carrying instructions 824 for execution by the machine 800, and includes digital or analog communications signals or other intangible medium to facilitate communication of such software.

In an example embodiment, a computerized method comprises receiving, at a content access device, an identification corresponding to a viewing profile stored in a database, the viewing profile comprising media content information identifying an available media content item; and challenge information identifying a challenge to be presented to allow consumption of the available media content item, a reference response to the challenge; and a challenge rule; causing, by the content access device, based on the received identification, presentation of the challenge; receiving, at the content access device, a response to the challenge; comparing the received response to the reference response; determining whether presentation of the available media content item is currently allowable based on the comparing of the received response to the reference response and on the challenge rule; and based on a determination that presentation of the available media content item is currently allowable, causing, by the content access device, presentation; via a display device, of the available media content item.

In another example embodiment, including all previous example embodiments, the viewing profile further comprises current viewing allowance information indicating whether viewing of media content is currently allowed; and the method further comprises preventing presentation of media content based on the current viewing allowance information indicating that viewing of media content is not currently allowed.

In another example embodiment, including all previous example embodiments, the computerized method further comprises updating, based on the causing of the presentation of the available media content item, the current viewing allowance information.

In another example embodiment, including all previous example embodiments, the challenge comprises a first challenge; the available media content item comprises a first available media content item; the media content information identifies a second available media content item; the challenge information identifies a second challenge to be presented to allow consumption of the second available media content item; and the computerized method further comprises preventing presentation of additional media content after the presentation of the first available media content item based on the updated current viewing allowance information indicating that viewing of additional media content is not currently allowed; and causing; by the content access device, presentation of the second challenge based on the updated current viewing allowance information indicating that viewing of additional media content is currently allowed.

In another example embodiment, including all previous example embodiments, the challenge comprises a question; and the causing of the presentation of the available media content item is based on the received response being a correct answer to the question.

In another example embodiment, including all previous example embodiments, the educational challenge comprises a puzzle; and the causing of the presentation of the available media content item is based on the received response being a solution to the puzzle.

In another example embodiment, including all previous example embodiments, at least one of the media content information and the challenge information are based on a chronological age associated with the viewing profile.

In another example embodiment, including all previous example embodiments, at least one of the media content information and the challenge information are based on previously presented challenge information corresponding to the viewing profile.

In another example embodiment, including all previous example embodiments, at least one of the media content information and the challenge information are based on previously presented media content corresponding to the viewing profile.

In another example embodiment, including all previous example embodiments, at least one of the media content information and the challenge information are based on an educational curriculum corresponding to the viewing profile.

In another example embodiment, including all previous example embodiments, the computerized method further comprises causing, by the content access device, based on the received notification, presentation of a user interface corresponding to the viewing profile, wherein the presentation of the challenge occurs via the user interface.

In another example embodiment, including all previous example embodiments, the available media content item comprises a video program.

In another example embodiment, including all previous example embodiments, the available media content item comprises a game.

In an example embodiment, a content access device comprises one or more hardware processors; and a memory storing instructions that, when executed by at least one of the one or more hardware processors, cause the content access device to perform operations comprising receiving an identification corresponding to a viewing profile stored in a database, the viewing profile comprising media content information identifying an available media content item, and challenge information identifying a challenge to be presented to allow consumption of the available media content item, a reference response to the challenge, and a challenge rule; causing, based on the received identification, presentation of the challenge; receiving a response to the challenge; comparing the received response to a reference response; determining whether presentation of the available media content item is currently allowable based on the comparing of the received response to the reference response and on the challenge rule; and based on a determination that presentation of the available media content item is currently allowable, causing presentation, via a display device, of the available media content item.

In another example embodiment, including all previous example embodiments, the content access device further comprises the display device.

In another example embodiment, including all previous example embodiments, the content access device comprises one of a desktop computer, a laptop computer, a tablet computer, a smart phone, and a smart television.

In another example embodiment, including all previous example embodiments, the content access device comprises one of a tablet computer, a smart phone, a set-top box, a streaming device, and a gaming device.

In another example embodiment, including all previous example embodiments, the identification is received from a remote control device separate from the content access device.

In another example embodiment, including all previous example embodiments, the remote control device comprises one of a tablet computer and a smart phone.

In another example embodiment, including all previous example embodiments, the response to the challenge is received from the remote control device.

In an example embodiment, a non-transitory computer-readable storage medium stores instructions that, when executed by at least one hardware processors of a content access device, cause the content access device to perform operations comprising receiving an identification corresponding to a viewing profile stored in a database, the viewing profile comprising media content information identifying an available media content item, and challenge information identifying a challenge to be presented to allow consumption of the available media content item, a reference response to the challenge, and a challenge rule; causing, based on the received identification, presentation of the challenge; receiving a response to the challenge; comparing the received response to the reference response; determining whether presentation of the available media content item is currently allowable based on the comparing of the received response to the reference response and on the challenge rule; and based on a determination that presentation of the available media content item is currently allowable, causing presentation, via a display device, of the available media content item.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain example embodiments are described herein as including logic or a number of components, modules, or mechanisms, Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 802 or a group of processors 802) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the inventive subject matter has been described with reference to specific example embodiments, various modifications and changes may be made to these example embodiments without departing from the broader scope of embodiments of the present disclosure. For example, various embodiments or features thereof may be mixed and matched or made optional by a person of ordinary skill in the art. Such embodiments of the inventive subject matter may be referred to herein, individually or collectively, by the term “invention” merely for convenience and without intending to voluntarily limit the scope of this application to any single inventive concept if more than one is, in fact, disclosed.

The example embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A computerized method comprising:
receiving, at a user device, an identification corresponding to a viewing profile stored in a database; the viewing profile comprising:
media content data identifying a media content item available for consumption via a display device;
challenge information identifying a plurality of challenges to be presented to a user to allow consumption of the media content item, and a corresponding reference response to each challenge; and
an indication of a predetermined number of tries after which to allow presentation of the media content item;
causing, by the user device and based on the received identification, presentation of the plurality of challenges to the user via a user interface;
receiving, at the user device; via the user interface, a response to each challenge;
identifying at least one incorrect response to the plurality of challenges by comparing, for each challenge, the received response to the corresponding reference response;
determining that presentation of the media content item is allowable despite the at least one incorrect response, based on a count of the plurality of challenges being at least the predetermined number of tries; and
based on the determination that the presentation is allowable, allowing presentation of the media content item on the display device.

2. The computerized method of claim 1, wherein:
the viewing profile further comprises current viewing allowance information indicating whether viewing of media content is currently allowed; and
the causing of the presentation of the media content item is further based on the current viewing allowance information indicating that viewing of media content is currently allowed.

3. The computerized method of claim 2, wherein the computerized method further comprises updating, based on the causing of the presentation of the media content item, the current viewing allowance information.

4. The computerized method of claim 3, wherein
the media content item comprises a first media content item;
the media content data identifies a second media content item;
the challenge information identifies a second challenge to be presented to allow consumption of the second media content item; and
the computerized method further comprises:
preventing presentation of additional media content after the presentation of the first media content item based on the updated current viewing allowance information indicating that viewing of additional media content is not currently allowed; and
causing, by the user device, presentation of the second challenge based on the updated current viewing allowance information indicating that viewing of additional media content is currently allowed.

5. (canceled)

6. (canceled)

7. The computerized method of claim 1, wherein at least one of the media content data and the challenge information are based on a chronological age associated with the viewing profile.

8. The computerized method of claim 1, wherein at least one of the media content data and the challenge information are based on previously presented challenge information corresponding to the viewing profile.

9. The computerized method of claim 1, wherein the plurality of challenges are presented based on a viewing history comprising information regarding previously presented media content corresponding to the viewing profile.

10. The computerized method of claim 1, wherein at least one of the media content data and the challenge information are based on an educational curriculum corresponding to the viewing profile.

11. (canceled)

12. The computerized method of claim 1, wherein the media content item comprises a video program.

13. The computerized method of claim 1, wherein the media content item comprises a game.

14. A user device comprising:
one or more hardware processors; and
a memory storing instructions that, when executed by at least one of the one or more hardware processors, causes the user device to perform operations comprising:
receiving an identification corresponding to a viewing profile stored in a database, the viewing profile comprising:
media content data identifying a media content item available for consumption via a display device;
challenge information identifying a plurality of challenges to be presented to a user to allow consumption of the media content item, and a corresponding reference response to each challenge; and
an indication of a predetermined number of tries after which to allow presentation of the media content item;
causing, based on the received identification, presentation of the plurality of challenges to the user via a user interface;
receiving, via the user interface, a response to each challenge;
identifying at least one incorrect response to the plurality of challenges by comparing, for each challenge the received response to the corresponding reference response;
determining that presentation of the media content item is allowable despite the at least one incorrect response, based on a count of the plurality of challenges being at least the predetermined number of tries; and
based on the determination that the presentation is allowable, allowing presentation of the media content item on the display device.

15. The user device of claim 14, wherein the user device further comprises the display device.

16. The user device of claim 15, wherein the user device comprises one of a desktop computer, a laptop computer, a tablet computer, a smart phone, and a smart television.

17. The user device of claim 14, wherein the user device comprises one of a tablet computer, a smart phone, a set-top box, a streaming device, and a gaming device.

18. The user device of claim 14, wherein the identification is received from a remote control device separate from the user device.

19. The user device of claim 18, wherein the remote control device comprises one of a tablet computer and a smart phone.

20. The user device of claim 18, wherein the response to each challenge is received from the remote control device.

21. A non-transitory computer-readable storage media storing instructions that, when executed by at least one hardware processor of a user device, cause the user device to perform operations comprising:
receiving an identification corresponding to a viewing profile stored in a database, the viewing profile comprising:
media content data identifying a media content item available for consumption via a display device, and
challenge information identifying a plurality of challenges to be presented to a user to allow consumption of the media content item, and, a corresponding reference response to each challenge; and
an indication of a predetermined number of tries after which to allow presentation of the media content item;
causing, based on the received identification, presentation of the plurality of challenges to the user via a user interface;
receiving, via the user interface, a response to each challenge;
identifying at least one incorrect response to the plurality of challenges by comparing, for each challenge, the received response to the corresponding reference response;
determining that presentation of the media content item is currently despite the at least one incorrect response, based on a count of the plurality of challenges being at least the predetermined number of tries; and
based on the determination that the presentation is allowable, allowing presentation of the media content item is on the display device.
